(19) United States
(12) Patent Application Publication
(10) Pub. No.: US 2012/0246555 A1
(43) Pub. Date: Sep. 27, 2012

(54) SYSTEMS AND METHODS FOR SUBMITTING A REQUEST FOR GOODS, SERVICES, AND/OR INFORMATION, SUCH AS GOODS, SERVICES, OR INFORMATION RELATED TO HEALTHCARE

(76) Inventor: Ryan Masten, Austin, TX (US)

(21) Appl. No.: 13/429,049

(22) Filed: Mar. 23, 2012

Related U.S. Application Data
(60) Provisional application No. 61/466,762, filed on Mar. 23, 2011.

(51) Int. Cl. G06F 15/16; H04L 9/32; G06F 21/00; G06F 17/00

(52) U.S. Cl. 715/234; 709/217; 726/7

(57) ABSTRACT

Methods and systems are described for submitting a request for goods, services, and/or information to a third party. Using a computing device, a first user submits information associated with the request for goods, services, and/or information. The first user submits the information using input fields displayed on a user interface of the computing device. Using a computing device, a second user views the information submitted by the first user and updates the information. The second user sends the request for goods, services, and/or information to the third party.

### CROSS-REFERENCE TO RELATED APPLICATION(S)

This application claims the benefit of U.S. Provisional Application No. 61/466,762 filed on Mar. 23, 2011, which is incorporated herein by reference in its entirety.

### BACKGROUND

A professional's time is valuable. Every minute that he or she is not practicing his or her craft can amount to money lost. A professional may employ a support staff and use technology to increase the proportion of time he or she spends performing specialized tasks. Although both tactics improve a professional's efficiency, gaps exist among a professional's specialized talent, the work performed by the professional's staff, and technology. As a result, a professional spends valuable time completing duties that, although necessary for his or her profession, do not require the professional's valuable skill set.

A number of factors contribute to these gaps. One is inefficiencies related to communication. Although a professional may work with a staff whose skills complement his or her own, the professional must frequently communicate information to the staff to be supported effectively, and the professional must be accurate and complete in doing so. This is especially the case when a professional requires goods, services, or information from a third party and thus must be complete and accurate in his or her request to the third party for these goods, services, or information. Communicating the information necessary for these requests can be cumbersome. For example, to order lab work related to a patient, a physician could fill out a form and submit it to a lab himself or herself. But the physician typically communicates patient and order information to a nurse, who ultimately inputs the information into a computer system and submits the request to the lab. While it saves the physician time to have the nurse input and submit this information, time is wasted as the physician relays all the necessary information for this request, and information that the nurse could find elsewhere or might already know.

The need exists for a system that overcomes the above problems, as well as one that provides additional benefits. Overall, the examples herein of some prior or related systems and their associated limitations are intended to be illustrative and not exclusive. Other limitations of existing or prior systems will become apparent to those of skill in the art upon reading the following Detailed Description.

### BRIEF DESCRIPTION OF THE DRAWINGS

FIG. 1 is a diagram of a suitable environment in which a remote hosting system, an information submission system, and a quick entry security system may operate.

FIG. 2 is a diagram of a remote hosting system.

FIG. 3 is a block diagram of an information submission system.

FIG. 4 is a block diagram of a quick entry security system.

FIG. 5 is a flow diagram depicting a method performed by a remote hosting system to run a hosted web application and invoke native functionality on a computing device.

FIG. 6 is a flow diagram depicting a method performed by an information submission system to obtain information related to a request for goods, services, or information.

FIGS. 7A-C are representative interfaces for receiving a submission of information from a first user related to a request for goods, services, or information.

FIG. 8A-B are representative interfaces for receiving a submission of information from a second user related to a request for goods, services, or information.

FIG. 9 is a flow diagram depicting a method performed by a quick entry security system for allowing a quick entry to an application.

FIG. 10 is a representative interface for receiving a quick entry code for an application.

### DETAILED DESCRIPTION

A system is needed that facilitates the entry and submission of information associated with a request from a user to a third party for goods, services, and/or information. A system is also needed for generating an interface that a user can use to easily submit information related to the request for goods, services, and/or information. A system is also needed for launching an application that can be updated and managed remotely with ease, yet handles data securely. Furthermore, a system is needed for providing secure but quick access to an application by authorized users. The foregoing needs exist in the area of healthcare, among others.

A remote hosting system is described that displays hosted content on a computing device. The computing device launches a native application. The native application may be a shell application. The native application launches an embedded web browser. The embedded web browser launches a hosted web application. A cross platform framework included in the native application and the hosted web application provides the hosted web application native functionality on the computing device. For example, the hosted web application may call functions or obtain data that only native applications can access. The web application may utilize one code base that can be used across various platforms, as the cross platform framework of the native application integrates the web application into the various platforms. The remote hosting system may be especially useful in the area of healthcare.

An information submission system is also described. The information submission system allows a user to request goods, services, or information from a third party. One application of the information submission system is to enable a physician to submit a request to a lab to perform lab work. A first user submits a request for goods, services, or information, and submits information related to the request through input fields displayed on a user interface of a computing device (e.g., a mobile device). The request is added to a queue associated with a second user. Using a computing device, the second user selects an indication of the request for goods or services or information from the queue. The second user views information submitted by the first user and modifies or adds to the information using input fields. The second user finalizes the request for goods or services or information and sends a command to the information submission system to send the request and the submitted information to the third party.

A quick entry security system is described that provides a user access to an application. A user may use quick entry login credentials to access an application when certain conditions are met. Quick entry login credentials are different from full login credentials. The quick entry login credentials are more quickly entered by a user into a computing device than full login credentials. For example, full login credentials may include a username and password while quick entry login credentials include a short personal identification number. The quick entry security system may permit quick entry when a valid login session commenced using full login credentials is active. For example, a user may exit an application on a computing device but not log out of the application. The quick entry security system may permit the user access to the application using quick entry credentials if the user attempts to access the application within a predetermined time period of submitting full login credentials.

Various implementations of the invention will now be described. The following description provides specific details for a thorough understanding and an enabling description of these implementations. One skilled in the art will understand, however, that the invention may be practiced without many of these details. Additionally, some well-known structures or functions may not be shown or described in detail, so as to avoid unnecessarily obscuring the relevant description of the various implementations. The terminology used in the description presented below is intended to be interpreted in its broadest reasonable manner, even though it is being used in conjunction with a detailed description of certain specific implementations of the invention.

The following discussion includes examples of a remote hosting system, an information submission system, and a quick entry security system. The systems are described with respect to a number of processes that they may implement and numerous examples of how they may be implemented.

### Suitable Environments

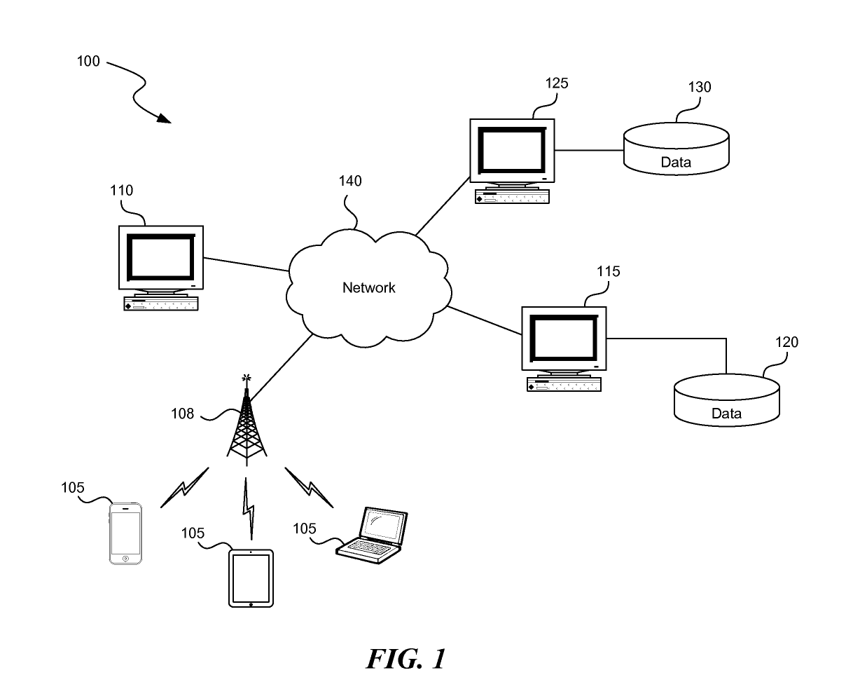

FIG. 1 and the following discussion provide a brief, general description of a suitable computing environment 100 in which a remote hosting system, an information submission system, and a quick entry security system can be implemented. Although not required, aspects and implementations of the invention will be described in the general context of computer-executable instructions, such as routines executed by a general-purpose computer or a mobile device, e.g., a personal computer or smartphone. Those skilled in the relevant art will appreciate that the invention can be practiced with other computer system configurations, including Internet appliances, set-top boxes, hand-held devices, wearable computers, mobile phones, laptops, netbooks, tablets, multiprocessor systems, microprocessor-based systems, minicomputers, mainframe computers, or the like. The invention can be embodied in a special purpose computer or data processor that is specifically programmed, configured, or constructed to perform one or more of the computer-executable instructions explained in detail below. Indeed, the terms “computer” and “computing device,” as used generally herein, refer to devices that have a processor and non-transitory memory, like any of the above devices, as well as any data processor or any device capable of communicating with a network, including consumer electronic goods such as gaming devices, cameras, or other electronics having a data processor and other components, e.g., network communication circuitry. Data processors include programmable general-purpose or special-purpose microprocessors, programmable controllers, application-specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical-based disks, flash memory devices, or any other type of non-volatile storage medium or non-transitory medium for data. Software may include one or more program modules, which include routines, programs, objects, components, data structures, and so on that perform particular tasks or implement particular abstract data types.

The invention can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the invention described below may be stored or distributed on tangible, non-transitory computer-readable media, including magnetic and optically readable and removable computer discs, stored in firmware in chips (e.g., EEPROM chips). Alternatively, aspects of the invention may be distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to the example of FIG. 1, a remote hosting system, an information submission system, and a quick entry security system operate in or among a first computing device, such as mobile devices 105, a second computing device, such as a computer 110 or another mobile device 105, and a server computer 115. The mobile device 110 and computer 115 include a network card or another device that enables them to communicate through one or more networks 140. The mobile device 110 and computer 115 communicate via the network 140 with the server 115. A data storage area 120 contains data pertaining to the remote hosting system, information submission system, and quick entry security system, and software necessary to perform functions of these systems. For example, the data storage area 120 may contain data pertaining to input fields, which are the fields that enable a user to submit information to the information submission system. The information submission system may communicate with one or more third party servers 125, which communicate with data storage areas 130. Once information has been submitted by a user into the information submission system, the information may be sent to third parties, such as those from whom the user wishes to request goods, services, or information. The information may be stored in the data storage areas 130 associated with the third party servers 125. The information submission system may also store data submitted by a user in other storage areas, such as in the data storage area 120 and data storage in the mobile device 105 and the computer 110.

The mobile devices 105 and computer 110 communicate with each other and the server 115 and third party server 125 through the networks 140, including, for example, the Internet. The mobile device 105 communicates wirelessly with a base station or access point 108 using a wireless mobile telephone standard, such as the Global System for Mobile Communications (GSM), or another wireless standard, such as IEEE 802.11, and the base station or access point 108 communicates with the server 115 and third party server 125 via the networks 140. The computer 110 communicates through the networks 140 using, for example, TCP/IP protocols.

### Suitable Systems

In some implementations, the remote hosting system, the information submission system, and the quick entry security system are each implemented in a common computing environment or system. For example, the information submission system may be implemented using a hosted web application of the remote hosting system. Each may also be implemented independently. The present section describes these systems individually for clarity's sake.

1. Remote Hosting System

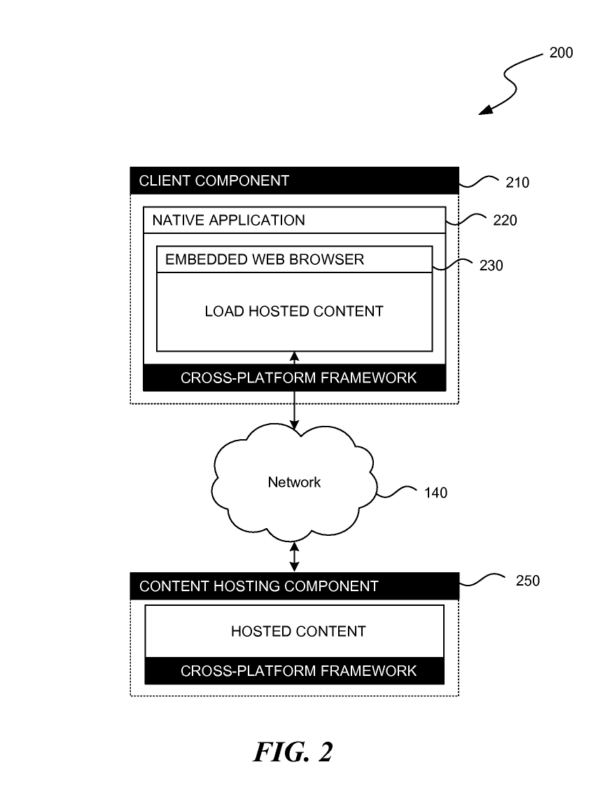

FIG. 2 is a diagram of a remote hosting system 200. The remote hosting system 200 enables cross-platform development of mobile applications across computing devices capable of embedding a web browser in a native application. The remote hosting system 200 includes a client component 210, a native application 220, an embedded web browser 230, and a content hosting component 250. The client component 210 and the content hosting component 250 may communicate over a network, such as the network 140 described above with respect to FIG. 1. The remote hosting system may be employed in the area of healthcare. For example, a physician may carry a mobile device that utilizes the remote hosting system to submit requests for lab work related to patients.

The client component 210 operates at least in part on a computing device, such as mobile devices 105. The client component launches the native application 220 and facilitates native functions of the computing device. The native application 220 may be a shell application. The native application 220 may be developed using an editor associated with the programming language of the computing device. For example, if the native application is operating on an iPhone®, the application may be developed using Xcode. The native application 220 launches the embedded web browser 230, which loads hosted content received from the content hosting component 250. The native application includes a network address of a location associated with hosted content of the content hosting component 250, and the native application provides the address to the embedded web browser. The native application may force the use of a Hypertext Transfer Protocol Secure (HTTPS) website. The native application is configured to periodically check whether a connection is detected between the client component 210 and the network 140 or the client component 210 and the content hosting component 250. The client component may generate a warning to alert a user of the computing device when no connection is detected.

The native application 220 and the hosted content utilize a cross-platform framework that allows for native functionality and a single hosted code base. The native application 220 may insert a header in data communicated by the client component to the content hosting component. The header may identify a user, a device, an operating system, or other data related to the client component 210. The content hosting component 250 may modify hosted content based on the header. For example, in some implementations the hosted content is a web application. The content hosting component may automatically modify the web application to change the look and feel of the application so that the user experiences the web application the same way that he or she would experience a native application.

The client component 210 provides native functionality of the computing device. Native functionality includes native alerts, Global Positioning System (GPS) data, and other functional elements that only native applications can access on a device. The native application 220 uses the cross-platform framework to invoke special JavaScript code within the hosted content to provide native functionality. The native application may monitor the hosted content for changes to a Document Object Model (DOM). When the native application detects changes to the DOM, it invokes native functionality corresponding to the change. The native application may also alter the DOM. In some implementations, the native application 220 connects to hosted content through a JavaScript bridge. Under such an implementation, either the native application 220 or the hosted content can invoke a JavaScript call to the other.

The native application 220 may store data related to hosted content so that the embedded web browser may load content when a network connection is unavailable. For example, the web browser may launch an application when the network connection is unavailable and may load the stored data. In some implementations, the data that the native application stores for offline access is non-sensitive data. For example, in an application for submitting a request for lab work, the data may include a description of services available from a third party but no personal information related to patients for whom the lab work may be performed.

2. Information Submission System

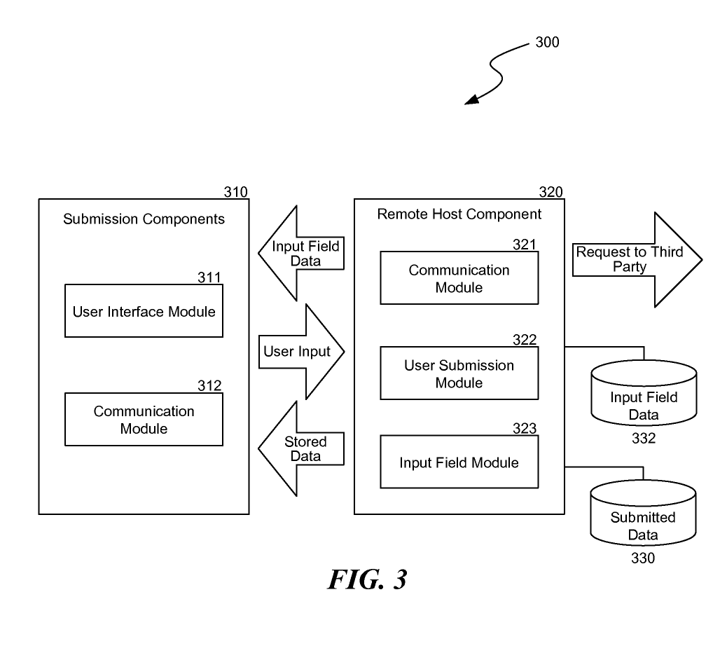

FIG. 3 is a block diagram of various components of an information submission system 300. The information submission system 300 includes submission components 310 and a remote host component 320. The submission components 310 include a user interface module 311 and a communication module 312. The remote host component 320 includes a communication module 321, a user submission module 322, and an input field module 323. The remote host component communicates with data storage areas 330, 332, which may contain data submitted to the information submission system 300 by a user and data related to input fields. In some examples, the information submission system is used in the healthcare industry, such as by a physician to order lab testing from a lab.

The information submission system 300 includes at least two submission components 310. The submission components 310 operate at least in part on a mobile device, like the mobile device 105 of FIG. 1, or another computing device, like the computer 110 of FIG. 1. As explained in detail herein, in some implementations, a first submission component operates in a mobile device, such as a smart phone, and a second submission component operates in a computer. A first user submits information related to a request through an application operating on the mobile device. And a second user, using the computer, submits information that supplements the information submitted by the first user. By not having to communicate or input all of the information himself or herself, the first user reduces the amount of time he or she spends conveying the necessary information for the request.

The user interface module 311 generates a user interface that allows a user to submit a request to a third party for goods, services, or information. The user interface module 311 may display input fields that enable a user to commence a process of submitting the request. For example, the user interface module 311 may display a hierarchy of input fields related to the request. The input fields may include, for example, third parties that the request may be sent to, the type of request that is to be submitted (e.g., lab testing), whether the request is a reorder or a new order, a subject of the request (e.g., a patient, a type of lab test), and so forth. The user interface module 311 also displays a user interface that includes input fields that are selected by the information submission system based on information submitted about the request and enables a user to submit information using the input fields. The user interface module 311 may automatically populate fields based on information submitted by a user. The user interface module 311 enables the user to submit information using input fields in a number of ways. For example, the user may type information into an input field, select information associated with an input field, record audio into an input field, dictate into an input field, or the like. The user interface module 311 receives commands from the user and stores data submitted by the user. The submission components 310 send information submitted by the user to the remote host component 320. The submission components 310 receive stored data from the remote host component 320 that was previously submitted by a user. Accordingly, the user interface module 311 may display information that was previously submitted by a user and permit a user to modify the previously submitted information.

The communication module 312 enables communication between the submission components 310 and the remote host component 320. The communication module 312 receives input field data and stored data from the remote host component 320. In some implementations, the communication module 312 sends data to third parties. The communication module 312 may provide an HTTPS connection with the remote host component. In some implementations, the communication module 312 is configured to insert a header in data sent to the remote host. The header may identify, for example, a mobile device associated with the submission component, an operating system of the mobile device, a user of the device, or the like.

The remote host component 320 stores data that is submitted through the submission components 310 and identifies and sends stored data and input field data to the submission components. The communication module 321 sends input field data and stored data to the submission components. For example, input field data may include drop-down menu input fields and information associated with each object of the drop-down menu input fields. Stored data may include information that was previously submitted by a user. For example, in an application for requesting lab work related to a patient, the communication module may send data associated with a previous order related to the patient. The communication module 321 also sends data, such as requests for goods, services, or information, to third parties.

The user submission module 322 stores information received from the submission components 310 in the storage area 330. The user submission module 322 may store the information in association with other data. For example, the user submission module may store information submitted using an input field in association with the input field. Similarly, the user submission module 322 stores information submitted with respect to a request for goods or services or information in association with the request. The user submission module also identifies stored data that is to be sent to the submission components 310. For example, the user submission module 322 may identify data submitted by a first user with respect to a request for goods and services so that it can be sent to the submission component associated with a second user for modification.

The input field module 323 identifies input fields stored in the storage area 332 to be sent to the submission components. The input field module 323 may identify input fields that are relevant for a particular request for goods, services, or information. For example, a submission component may receive a request from a user to submit a lab order related to a blood cholesterol test. The input field module 323 may identify input fields contained in data storage area 332 that are associated with blood cholesterol testing. As another example, a submission component may receive a request from a user to submit a lab order for a patient. Based on information submitted by a user, the input field module 323 may identify input fields related to the patient. For example, if the information submitted by a user identifies a patient as a female, the input field module may identify input fields related exclusively to female issues and disregard input fields related exclusively to male issues. An input field may be associated with another input field. For example, a first input field may be related to a test for HDL cholesterol and a second input field may be related to a test for triglyceride levels. If a user selects to have the test for HDL cholesterol performed, the input field module 323 may identify the input field associated with the test for triglyceride levels to be sent to the information submission components 310.

3. Quick Entry Security System

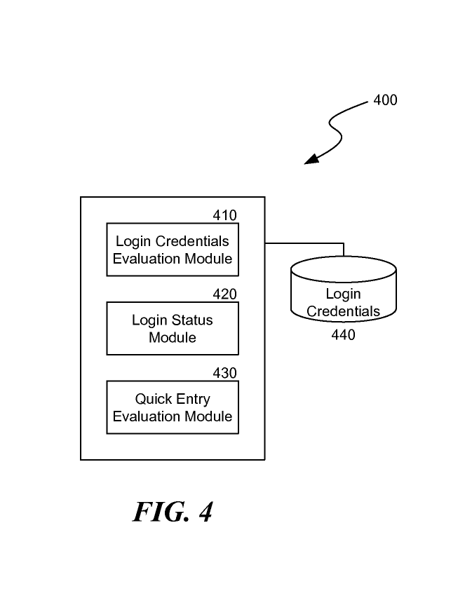

FIG. 4 is a block diagram of various components of a quick entry security system 400 for an application. The quick entry security system includes a login credentials evaluation module 410, a login status module 420, and a quick entry evaluation module 430. The quick entry security system 400 accesses login credentials in data storage 440. The login credentials evaluation module compares login credentials received from a user to login credentials contained in data storage 440. The login credentials evaluation module 410 evaluates both full login credentials and quick entry login credentials. The login credentials evaluation module 410 provides an indication of whether inputted login credentials match stored login credentials. Login credentials contained in data storage 440 may be encrypted. The login credentials evaluation module 410 may compare encrypted login credentials or may decrypt login credentials in order to make a comparison. The login credentials evaluation module 410 permits or denies access to the application based on a comparison of login credentials. One area that the quick entry security system is especially useful is in healthcare. For example, the quick entry security system may be used by a physician to access patient records on his or her mobile device.

The login status module 420 determines whether a user has a valid and/or active login session. The login status module 420 may invalidate a login session if a predetermined time period has passed since the login session began. The login status module 420 may terminate a login session if a user logs out of an application. The login status module 420 may deactivate a login session if a number of times that a user unsuccessfully attempts to log in with quick entry login credentials is greater than a threshold number.

The quick entry evaluation module 430 determines whether quick entry access to an application is permissible. The quick entry evaluation module 430 may determine that quick entry access is impermissible when a user has specifically declined to allow quick entry access. The quick entry evaluation module may determine that quick entry access is impermissible when the device that the application is operating on is outside of an approved geographic region. Other scenarios in which quick entry may not be permitted include when a number of failed quick entry attempts by a user reaches a predetermined threshold.

### Example Processes

1. Remote Hosting

A remote hosting system 200 enables cross-platform development of mobile applications across computing devices capable of embedding a web browser in a native application. Accordingly, one application for the remote hosting system 200 is for running an application on a mobile device. The remote hosting system may be utilized in the area of healthcare. For example, physician may use a mobile device that utilizes the remote hosting system to order lab work related to a patient.

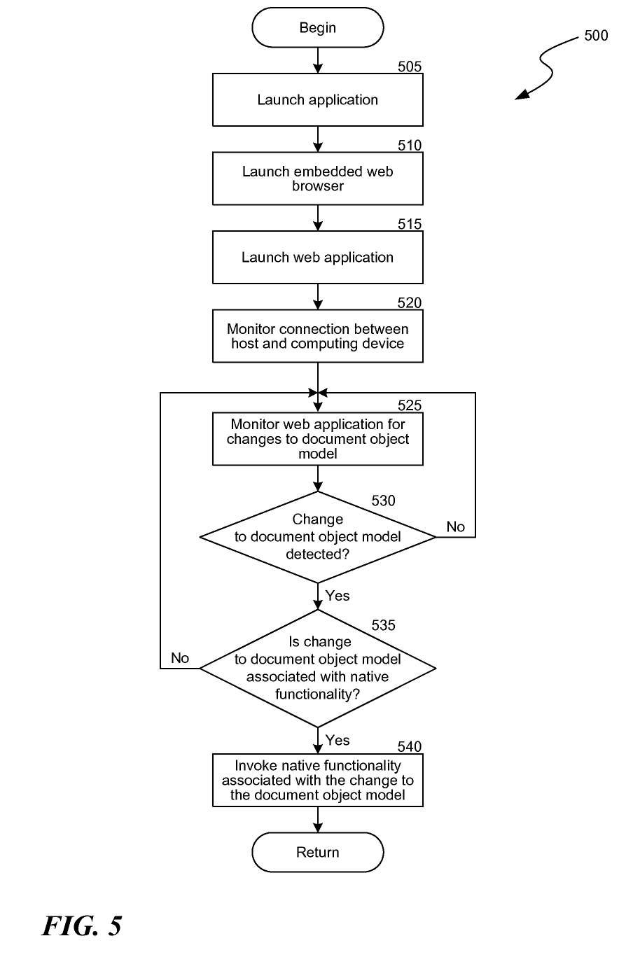

FIG. 5 is a flow diagram representing a process 500 performed by a remote hosting system 200 for presenting a user interface for a native application running on a mobile device. At a block 505, the remote hosting system 200 launches a native application on the mobile device. In some implementations, the native application is a shell application developed in a native programming language of the mobile device. At a block 510, the remote hosting system 200 launches a web browser embedded in the native application. At a block 515, the web browser launches a hosted web application. In some implementations, the native application includes an address associated with the web application and directs the web browser to the hosted web application. The native application includes a cross-platform framework that allows for native functionality and a hosted code base. The web application may provide a user interface for the native application. In some implementations, the web application receives hosted content from an HTTPS website. In some implementations, the remote hosting system 200 detects an operating system associated with the computing device and optimizes the web application for that operating system. For example, a mobile device may include an indication of an operating system of the mobile device in a request for web application data from a remote host. The remote hosting system 200 may modify the web application for the operating system, changing, for example, the look, feel, and functionality of the web application so that the user of the mobile device feels as if he or she were using a strictly native application.

At a block 520, the remote hosting system 200 monitors a network connection between the host of the hosted website and the mobile device running the native application. In some implementations, if the network connection is lost, the remote hosting system 200 issues an alert and pauses the web application until a connection is restored. For example, the native application may generate an alert on the mobile device when no connection is detected and the web application may be paused. In some implementations, the remote hosting system 200 stores data related to an “offline” mode while the network connection is established. When the connection is lost, the web application can access the data. Accordingly, a user of the mobile device can still access data associated with the web application when a network connection is not available. In some implementations, data available in the offline mode is limited to non-sensitive data. For example, for a web application used to submit lab orders, an offline mode may provide a description of lab work available from a particular laboratory but no confidential information related to a patient for whom lab work has been ordered.

The remote hosting system provides for native functionality for the web application on the computing device. At a block 525, the remote hosting system 200 monitors the web application for changes to a DOM. At a decision block 530, the remote hosting system determines whether any changes to the DOM have been detected. If no changes are detected, the process 500 proceeds back to block 525, and the remote hosting system continues to monitor the web application for changes to the DOM. If changes to the DOM have been detected, the process 500 proceeds to a decision block 535, and the remote hosting system determines whether the change to the DOM is associated with native functionality on the computing device. If the change to the DOM is not associated with native functionality on the device, the process 500 returns to block 525, and the remote hosting system continues to monitor the web application for changes to the DOM. If the change to the DOM is associated with native functionality, the process proceeds to a block 540, and the remote hosting system invokes native functionality associated with the change to the DOM. For example, a change to a DOM may be associated with a request to obtain data from a GPS on the device. In some implementations, the native application and the web application communicate with each other via a JavaScript bridge. Accordingly, the web application may invoke native functionality using a JavaScript call to the native application.

Because a hosted web application is provided inside the native application, the user experiences the web application as he or she would a native application. However, because the content of the application is hosted remotely, the application's developer may update the web application and, hence, the interface presented to the user without the hassle and security issues involved with pushing updates to native applications. Furthermore, a developer need only code the native application in the language of the computing device used by the user, providing flexibility to a developer through the use of one code for different devices.

2. Submission of Information

One application for the information submission system 300 is in facilitating a request from a user to a third party for goods, services, or information (e.g., a request for lab work related to a patient). The first user and a second user share in the responsibility of submitting information related to the request. An example used throughout this description involves a physician who commences an order for lab work using the information submission system and a nurse who supplements the order with information, such as billing information, before sending the order to a lab.

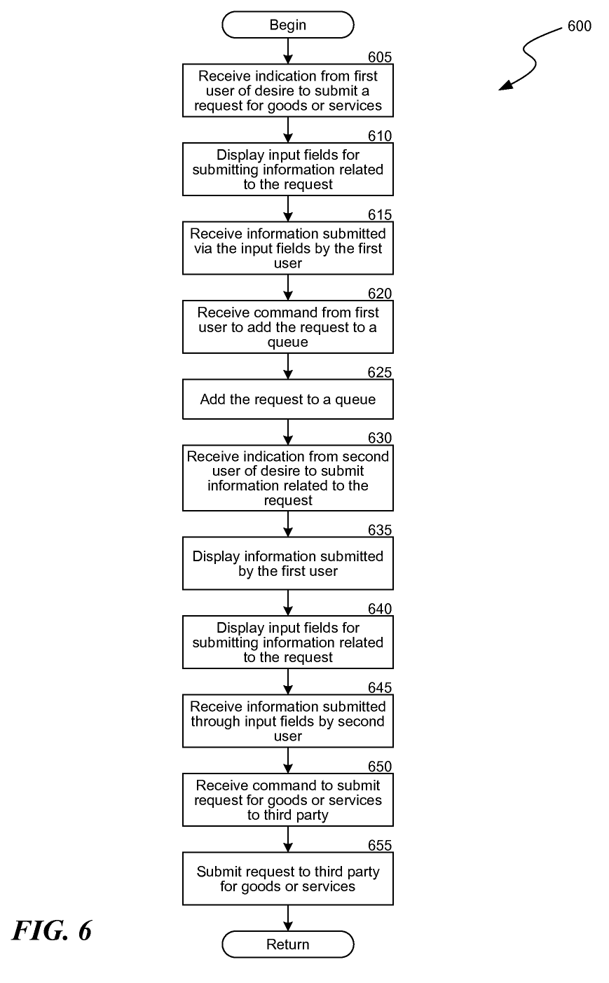

FIG. 6 is a flow diagram representing a process 600 performed by the information submission system 300 for submitting a request to a third party for goods, services, or information. At a block 605, the information submission system 300 receives an indication from a first user to submit a request for goods or services or information to a third party. The first user uses a computing device, such as a mobile device, to interact with and submit information to the information submission system 300. In some implementations, the first user interacts with the information submission system using a web application. For example, a mobile device may run a shell application that has embedded therein a web browser that runs the web application.

The first user may request to submit information in association with a subject. For example, the first user may select to commence an order that is related to the patient record or test result. In some implementations, the information submission system 300 displays various options for requesting goods, services, or information. For example, the information submission system may display a patient record and an option to place a new order for the patient or a reorder based on a previous request.

After receiving the indication of the request, the process 600 proceeds to a block 610, and the information submission system 300 displays input fields for submitting information related to the request. Input fields enable a user to submit information to the information submission system. The information submission system may use any of a number of different input fields. Examples include text input fields, checkbox input fields, radio button input fields, and drop-down menu input fields. Input fields can be associated with information, and when a user selects an input field, the information associated with that input field may be submitted to the information submission system. For example, if a checkbox input field is associated with the string “LDL Cholesterol,” a user can select the checkbox input field to submit the information “LDL Cholesterol” to the information submission system. Other types of input fields require a user to input information in other ways, such as by typing words or numbers or speaking into a microphone of a mobile device.

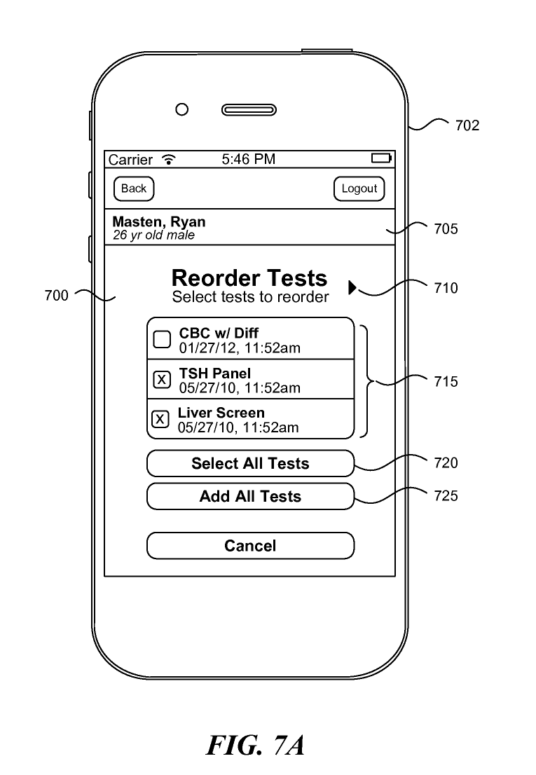

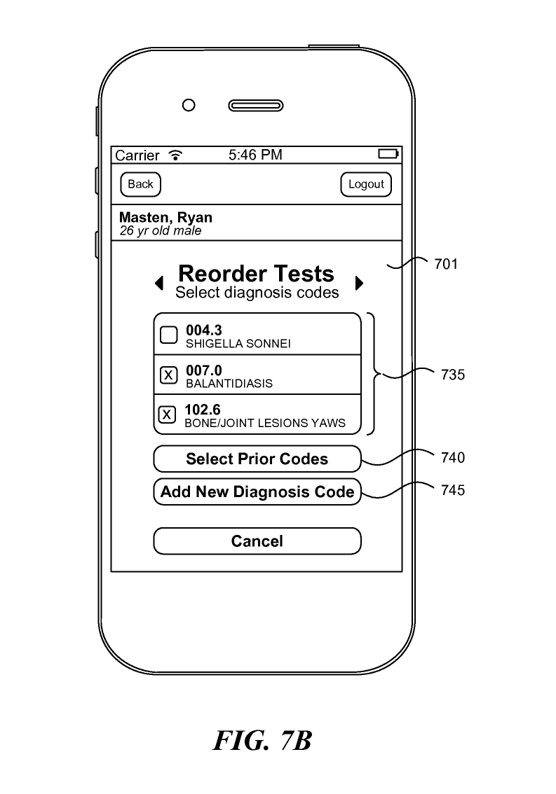

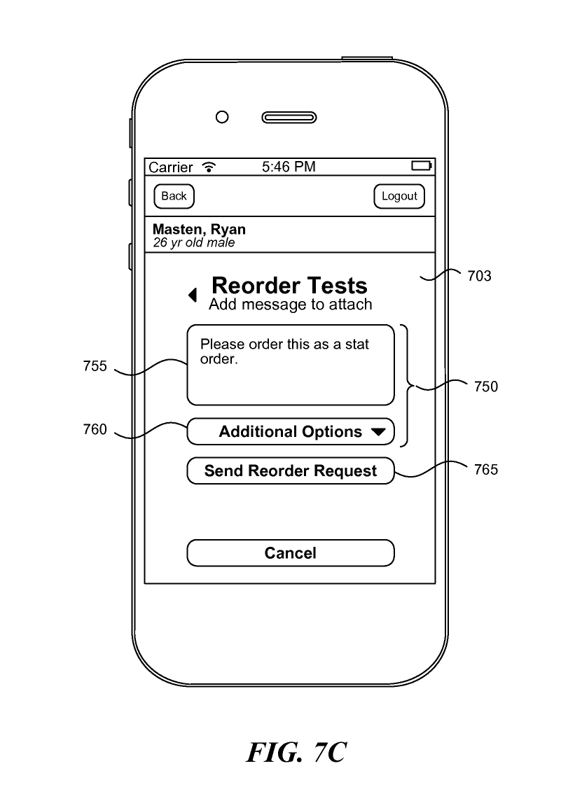

FIG. 7A-C show representative user interfaces that include a series of input fields. The user interfaces are displayed by a mobile device but stored remotely from the mobile device. For example, the user interfaces may be generated by a web application hosted on a server and downloaded to the mobile device by a shell application through an embedded web browser. FIG. 7A shows a representative user interface 700 generated on a mobile device 702 by an information submission system after a physician (i.e., a first user) selects to reorder lab tests associated with a patient. The user interface 700 displays information related to the request, such as a name 705 of the patient and that the order is a reorder. The user interface also displays checkbox input fields 715 associated with the request. The input fields are related to tests to reorder. When the user requests to reorder tests for the patient, the web application sends patient information along with the request to the server that hosts the web application. The server accesses a database of records to identify previous tests for the patient and sends the input fields related to the request and the reorder. Accordingly, the information submission system may display suggested information for the user to submit or may send input fields to the mobile device that are selected by the information submission system based on the information that the first user submits with the request. For example, because the physician selected a reorder, the input fields 715 associated with the request identify various tests that have been completed in the past with regard to the patient.

Returning to FIG. 6, the process 600 proceeds to a block 615, and the information submission system receives information submitted via at least one input field. In some implementations, information is submitted as soon as the user inputs information into an input field or selects an input field or a component of an input field (e.g., an option in a drop-down list). In some implementations, the information is not submitted until a user selects a button or otherwise indicates a willingness to submit the information. In the example discussed with respect to FIGS. 7A-C, a physician submits information associated with a reorder for a patient using a series of input fields. In FIG. 7A, the physician identifies information to be submitted by selecting checkbox input fields that are associated with the information “TSH Panel” and “Liver Screen.” The physician may select all displayed checkboxes by selecting a “Select All Tests” button 720. The physician may select an “Add All Tests” button 725 to add all test codes from the input fields 715. The physician may select an arrow 710 to proceed to a subsequent user interface that includes different input fields. As discussed below, the information that the physician identifies is submitted to the information submission system by selecting a button via a user interface presented to the physician.

As discussed above, FIGS. 7A-C show representative interfaces for ordering tests for a patient. The physician may identify the tests to reorder using the interface of FIG. 7A. The physician may select diagnosis codes using the interface of FIG. 7B. FIG. 7B shows a user interface 701 that includes checkbox input fields 735 associated with diagnosis codes. The information submission system displays a list of diagnosis codes from previous orders. The physician may select a “Select Prior Codes” button 740 to select the codes used in previous orders for that patient. The physician may select an “Add New Diagnosis Code” button 745 to add new diagnosis codes to the order that were not used previously. The physician may input notes related to an order using the interface of FIG. 7C. FIG. 7C shows a user interface 703 that includes text input fields 750 that allow the physician to add notes to the order. The input fields include a text input field 755 and a drop-down menu input field 760. In some implementations, the first user may dictate information into input fields. For example, the physician may select the text input field 755 and speak into a microphone of the mobile device, and software operating on the mobile device may record the spoken words and convert them into text that is inputted in the text input field 755.

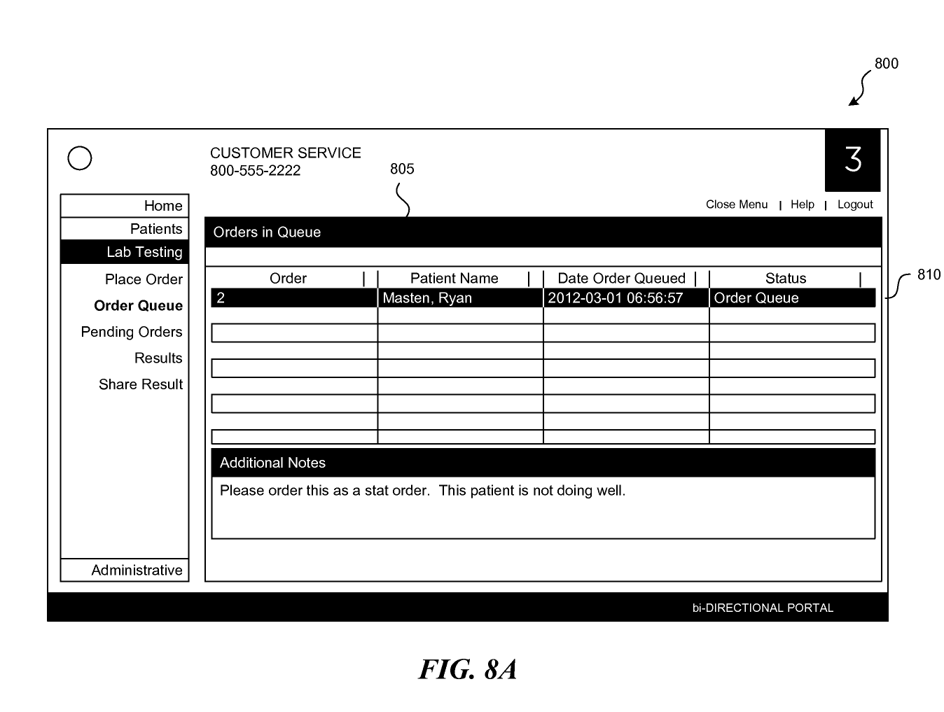

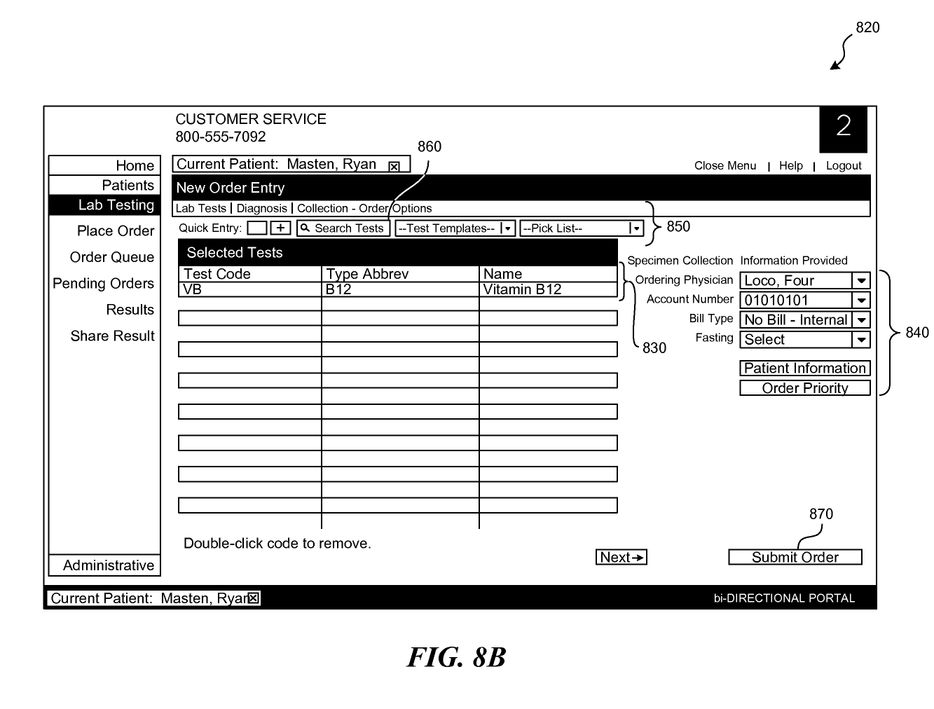

Referring back to FIG. 6, at a block 620, the information submission system receives a command from the first user to add the request to a queue. In some implementations, the request is added to the queue as a result of the first user selecting to submit the information inputted into input fields. In the example from FIGS. 7A-C, the physician may select a “Send Reorder Request” button 765, and the reorder request is added to a queue. At a block 625, the information submission system adds the request to a queue. In some implementations, the queue is associated with the first use, a second user, or a device associated with the second user. FIG. 8A, which is discussed below, shows a representative queue that may be displayed on the computing device associated with the second user.

The second user interacts with the information submission system using a computing device. In some implementations, the computing device is a laptop or desktop computer. The computing device may run an application that may be used by the second user to interact with the information submission system 300. In some implementations, the application embeds a web browser that opens a web application that the second user uses to interact with the information submission system 300.

At a block 630, the information submission system receives an indication from the second user of a desire to submit information related to the request. In some implementations, the second user indicates his or her desire by selecting a request from the queue. For example, FIG. 8A shows a representative user interface 800 displayed on a computer associated with a nurse (i.e., a second user) after a physician submits a reorder. The user interface displays a queue 805. The second user selects a queued item 810, e.g., by double-clicking on the item.

After the second user selects a queued item, the process 600 proceeds to a block 635, and the information submission system displays information submitted by the first user. For example, after the queued item 810 is selected, the information submission system generates a user interface that allows the second user to view information associated with the request (e.g., information submitted by the first user), edit the information associated with the request, and add information to the request. At a block 640, the information submission system displays input fields for submitting information related to the request. The information submission system may pre-populate some input fields. In some implementations, the information submission system pre-populates a field based on information submitted by either the first or second user and/or from information stored in a database.

Using the input fields, the second user can correct, update, and finalize the request for goods, services, or information. The input fields displayed by the information submission system may be selected based on a number of different considerations. In some implementations, the input fields are selected based on information submitted by the first user. In some implementations, the information submission system selects input fields based on a subject of the request, such as a patient that the request pertains to. In some implementations, the input fields are selected based on the third party or standards or request forms established by the third party. FIG. 8B shows a representative user interface 820 generated by the information submission system for inputting information related to a request. The user interface displays information 830 submitted by the first user related to various tests. The user interface displays drop-down list input fields 840 and 850. The nurse may supplement the information input by the physician by selecting an option from one of the drop-down list input fields 840 and 850 or through other options, such as a search input field 860, which may be used to search for different types of input fields that can be used to submit information. In addition, the nurse may select and modify the information 830 submitted by the physician.

At a block 645, the information submission system receives information submitted through input fields by the second user. In some implementations, the second user submits new information to the information submission system. In some implementations, the second user modifies information sent by the first user. In some implementations, the second user deletes information submitted by the first user. In the example from FIG. 8B, the nurse may, for example, submit information through drop-down input fields 840, such as whether the patient is fasting.

At a block 650, the information submission system receives a command to submit the request for goods and services to a third party. The command may be submitted by the second user after he or she has reviewed the information submitted by the first user and finalized the request by amending the information or by adding to it. The second user may issue the command to submit the request by selecting a button to do so. In some implementations, the second user may select to send information related to the request back to the first user. For example, the second user may send the information submitted by the second user back to the first user for the first user's approval before the information and the request is sent to the third party. For example, FIG. 8B shows a “Submit Order” button 870 that the nurse may select to send a command to submit the request for lab work to the lab. At a block 655, the information submission system submits the request for goods and services to a third party. In some implementations, the information submission system transfers the request to the third party over a network, such as the Internet. For example, the information submission system may send a file including all the information submitted by the second user, which includes the information submitted by the first user after it has been finalized by the second user.

By using the information submission system, a first user and a second user can find a productive balance between maintaining the completeness of information submitted by the first user with respect to a request for goods, services, or information, and minimizing the time that it takes the first and second users to submit the information needed for the request. By reducing the amount of information that the first user must submit to the system but maintaining the quality and completeness of the information by having the second user review and modify the submitted information, the information submission system increases both the speed by which a request for goods, services, or information may be submitted and the accuracy of the information included in the request.

3. Quick Entry Security

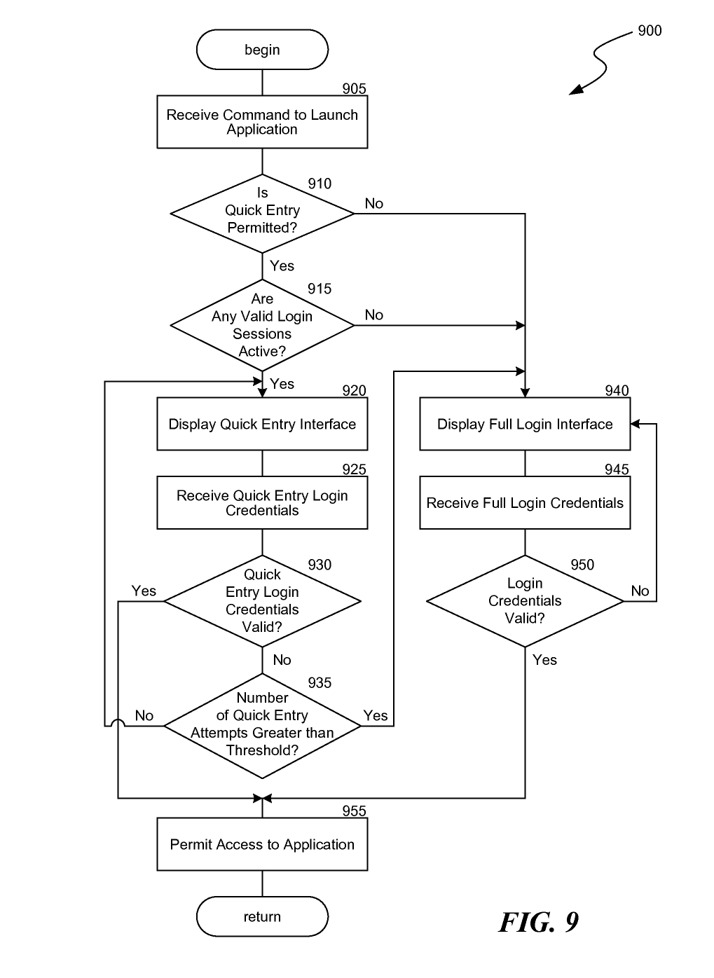

One application for the quick entry security system 400 is for permitting quick entry access to an application operating in a computing system, such as a mobile device. For example, the quick entry security system may be employed to control access to an application on a mobile device used by a physician. FIG. 9 is a flow diagram representing a process 900 for permitting access to an application. The application may be any application requiring that a user input login credentials to access the application. In some implementations, the application is an operating system. In some implementations, the application is a web application. At a block 905, the quick entry security system receives a command to launch the application. In some implementations, a request to launch an application includes a request to access the application. In some implementations, the application is already running when the command is received to launch the application.

At a block 910, the quick entry security system 400 determines whether quick entry to the application is permitted. In some implementations, an application does not permit quick entry. For example, an application may require that particular users input full login credentials every time that they access the application. In some implementations, an application does not permit quick entry at particular times, such as outside of a user's working hours or during a high-security situation, or at particular locations, such as outside of a secure area. In some implementations, quick entry is not permitted if a user requests to perform an advanced function or change personal settings. For example, quick entry may not be permitted if the user wishes to change his or her full login credentials. If quick entry is not permitted, the process 900 proceeds to a block 940, and the quick entry security system displays a full login interface.

If quick entry is permitted, the process proceeds to a block 915. At decision block 915, the quick entry security system determines whether any valid login sessions are active. A valid login session may exist if a user has previously established a login session by submitting valid full login credentials and the login session has not expired. A valid login session expires when a user logs out of the login session. In some implementations, a valid login session expires after a predetermined time period passes from when the login session was initiated. The user may adjust settings related to the application to specify the predetermined time period that a login session will remain valid after the login session has commenced. In some implementations, a valid login session to an application expires after a predetermined time period passes from when the application was closed. If no valid login sessions are active, the process 900 proceeds to block 940. If valid login sessions are active, the process 900 proceeds to a block 920.

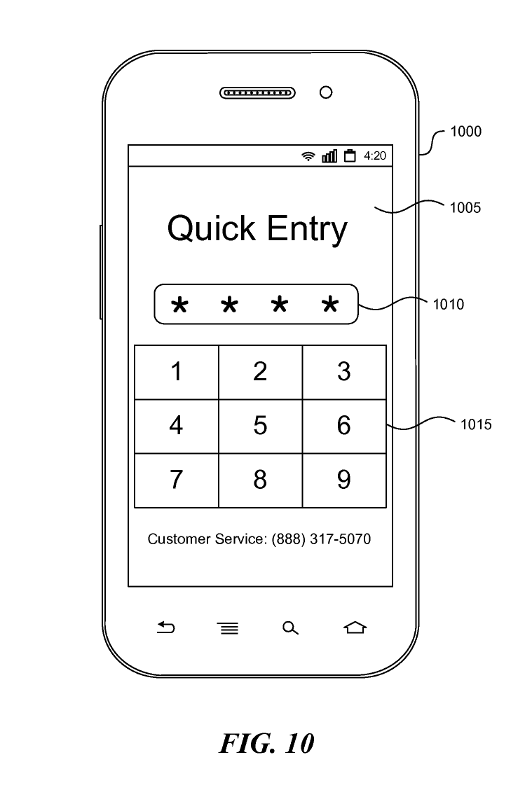

At block 920, the quick entry security system 400 displays a quick entry user interface. FIG. 10 shows an example user interface 1005 displayed on a mobile device 1000 for a user to submit quick entry login credentials. The user interface 1005 generated by the quick entry security system includes an input field 1010 and a keypad 1015 for submitting quick entry login credentials. In some implementations, quick entry login credentials include numbers. For example, quick entry login credentials may include a personal identification number (PIN) consisting of four numbers. In some implementations, quick entry login credentials include letters. Quick entry login credentials are different from full login credentials. Compared to full login credentials, quick entry login credentials may be shorter or may allow for quicker entry. In some implementations, full login credentials include a username and password and quick entry login credentials include a single string of numbers or letters.

Returning to FIG. 9, at a block 925, the quick entry security system 400 receives quick entry login credentials. At a decision block 930, the quick entry security system 400 determines whether the quick entry login credentials received at block 925 are valid. Received quick entry login credentials may be valid if they match quick entry login credentials stored in association with the active login session. The stored login credentials may be encrypted and stored by the application. If the received quick entry login credentials are valid, the process 900 proceeds to a block 955, and the quick entry security system 400 permits the user access to the application. In some implementations, access to the application includes access to data displayed by the application. In some implementations, access to the application includes an ability to modify data associated with the application. In some implementations, access to the application includes full access for using the application.

If the quick entry login credentials are not valid, the process 900 proceeds to a decision block 935, and the quick entry security system determines whether a number of quick entry attempts is greater than a threshold number. If the number of attempts is not greater than the threshold number, the process returns to block 920, and the quick entry security system displays the quick entry user interface again. If the number of attempts is greater than or equal to the threshold number, the process 900 proceeds to block 940, and the quick entry security system displays the full login interface. For example, the quick entry security system may display a username field and a password field. At a block 945, the quick entry security system receives full login credentials. At a decision block 950, the quick entry security system determines whether the login credentials are valid. For example, the quick entry security system may compare a received username and password to usernames and associated passwords encrypted and stored in association with the application. If the login credentials are not valid (e.g., the username or password did not match a username and password combination stored in association with the application), the process 900 returns to block 940, and the quick entry security system displays the full login interface. If the login credentials are valid, the process proceeds to block 955, and access is permitted to the application.

The quick entry security system improves a user's work flow. Traditionally, the user would be required to enter full login credentials every time the user needed to access an application. Adding quick entry functionality to the application provides a needed level of security while requiring less input from a user.

### CONCLUSION

Those skilled in the art will appreciate that the actual implementation of a data storage area may take a variety of forms, and the phrase “data storage area” is used herein in the generic sense to refer to any area that allows data to be stored in a structured and accessible fashion using such applications or constructs as databases, tables, linked lists, arrays, and so on. Those skilled in the art will further appreciate that the depicted flow charts may be altered in a variety of ways. For example, the order of the blocks may be rearranged, blocks may be performed in parallel, blocks may be omitted, or other blocks may be included.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” and any variant thereof mean any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at times shown as being performed in series, these processes or blocks may instead be performed or implemented in parallel, or may be performed at different times. Further, any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates the various aspects of the invention in any number of claim forms. For example, while only one aspect of the invention is recited as a means-plus-function claim under 35 U.S.C §112, sixth paragraph, other aspects may likewise be embodied as a means-plus-function claim, or in other forms, such as being embodied in a computer-readable medium. (Any claims intended to be treated under 35 U.S.C. §112, ¶ 6 will begin with the words “means for,” but use of the term “for” in any other context is not intended to invoke treatment under 35 U.S.C. §112, ¶ 6.) Accordingly, the applicant reserves the right to pursue additional claims after filing this application to pursue such additional claim forms, in either this application or in a continuing application.

I/We claim:

1. A method of presenting hosted content on a mobile device, wherein the hosted content is associated with healthcare, the method performed by a mobile device having a processor and a memory, the method comprising:
launching a native application, wherein the native application includes a cross-platform framework and an address associated with a network location that is associated with hosted content;
launching a web browser, wherein the web browser is embedded in the native application;
providing the web browser with the address associated with the network location that is associated with the hosted content, wherein the network location is associated with a provider of healthcare services;
sending a request to the network address associated with the network location for the hosted content;
receiving the hosted content, wherein the hosted content includes the cross-platform framework; and
presenting the hosted content using the web browser, wherein the hosted content is associated with healthcare.

2. The method of claim 1, further comprising:
monitoring the hosted content for changes to a Document Object Model (DOM);
detecting a change to the DOM, wherein the change to the DOM is associated with native functionality on the mobile device; and
performing the native functionality on the mobile device that is associated with the change to the DOM.

3. The method of claim 1, further comprising:
establishing a communication bridge between the native application and the hosted content using the cross-platform framework; and
performing native functionality on the mobile device based on an instruction from the hosted content.

4. The method of claim 1, wherein the native application is a shell application.

5. The method of claim 1, wherein the request sent to the address associated with the network location identifies at least one of the mobile device, an operating system of the mobile devise, and a user.

6. The method of claim 3, wherein the communication bridge is a JavaScript bridge.

7. The method of claim 1, further comprising:
monitoring a network connection between the mobile device and the network location;
detecting a loss of the network connection; and
generating an alert and pausing the web content when the loss of the network connection is detected.

8. A method of submitting a request for goods, services, and/or information to a third party, the method performed by a computing system that includes a processor and a memory, the method comprising:
receiving an indication from a first computing device of a user's desire to submit a request to a third party for goods, services, and/or information;
receiving, from the first computing device, information pertaining to the request for goods, services, and/or information;
sending an indication of the request for goods, services, and/or information to a second computing device, wherein the second mobile device is associated with a second user;
sending the information pertaining to the request for goods, services, and/or information to the second computing device;
receiving, from the second computing device, information pertaining to the request for goods, services, and/or information;
receiving, from the second computing device, an indication of a desire to submit the request for goods, services, and/or information to the third party; and
sending the request to the third party for goods, services, and/or information,
wherein the request includes at least some of the information pertaining to the request for goods, services, and/or information received from the first user, and
wherein the request includes the information pertaining to the request for goods, services, and/or information received from the second user.

9. The method of claim 8, further comprising:
sending to the first computing device data associated with input fields,
wherein the input fields are selected based at least in part on the indication from the first computing device of the user's desire to submit the request to the third party for goods, services, and/or information.

10. The method of claim 9, wherein:
the indication from the first computing device of the user's desire to submit the request to the third party for goods, services, and/or information includes an identification of a subject of the request; and
the input fields are selected based on the subject of the request.

11. The method of claim 10, wherein the subject of the request is a patient of a physician.

12. The method of claim 9, wherein:
the indication from the first computing device of the user's desire to submit the request to the third party for goods, services, and/or information includes an identification of a service performed by the third party; and
the input fields are selected based on the service performed by the third party.

13. The method of claim 12, wherein the service is a lab analysis.

14. The method of claim 11, wherein the input fields are selected based at least in part upon a previous request submitted to the third party related to the subject.

15. A method for permitting access to an application, the method performed by a computing system having a processor and a memory, the method comprising:
receiving a request from a user access an application;
determining whether quick entry access to the application is available for the user;
when quick entry access is determined to not be available:
displaying an interface for submitting full login credentials,
receiving an input representing full login credentials,
determining that the full login credentials match stored full login credentials, and
permitting the user access to the application; and
when quick entry access is determined to be available:
displaying an interface for submitting quick entry login credentials,
receiving an input representing quick entry login credentials,
determining that the quick entry login credentials match stored quick entry login credentials, wherein the quick entry login credentials are different from the full login credentials, and
permitting the user access to the application.

16. The method of claim 15, wherein quick entry access is permitted if a full login session is active and valid.

17. The method of claim 16, wherein the full login session is active and valid if the user previously logged in to the application using full login credentials and has not logged out of the application.

18. The method of claim 16, wherein the full login session is active and valid if a predetermined time period has not passed since the user previously logged in to the application using full login credentials.

19. The method of claim 16, wherein the computer system is a mobile device, and wherein the full login session is active and valid if the user previously logged in to the application using full login credentials and the mobile device is within a predetermined geographic region.

20. The method of claim 15, wherein the full login credentials include a username and a first password and the quick entry login credentials include only a second password.
